(19) United States
(12) Patent Application Publication
(10) Pub. No.: US 2026/0292960 A1
(43) Pub. Date: Sep. 24, 2026

(54) Driver for a Lighting Apparatus, the Lighting Apparatus, and a Light Management System Comprising the Lighting Apparatus

(71) Applicant: LEDVANCE GmbH, Garching bei München (DE)

(72) Inventor: Philipp KLIER, München (DE)

(21) Appl. No.: 19/570,294

(22) Filed: Mar. 18, 2026

(30) Foreign Application Priority Data
Mar. 18, 2025 (DE) 102025110312.7

(51) Int. Cl. H05B 47/19

(52) U.S. Cl. CPC H05B 47/19

(57) ABSTRACT

A driver for a lighting apparatus is provided. The driver comprises a power section for supplying electrical power to at least one light source of the lighting apparatus and a control unit for controlling the power section. The driver further comprises a communication module for representing the lighting apparatus externally and an interface for connecting at least one peripheral device to the driver. The control unit is configured to be operated in an open control mode in which at least one peripheral device connected to the interface can be represented externally as an independent network device via the communication module of the driver. A lighting apparatus and a light management system are also proposed.

### CROSS-REFERENCE TO RELATED APPLICATIONS

This patent application claims the benefit of and priority to German Patent Application No. 102025110312.7, filed on Mar. 18, 2025, which is herein incorporated by reference in its entirety.

### FIELD OF THE DISCLOSURE

The present disclosure generally relates to drivers for lighting apparatuses. In particular, the present disclosure relates to a driver for a lighting apparatus, the lighting apparatus, and a light management system (LMS) comprising the lighting apparatus.

### BACKGROUND

Lighting apparatuses with light sources and drivers for driving light sources are known. Light management systems (or LMSs) are also known, in which lighting apparatuses if necessary are combined with other network devices or network-compatible devices to form a system.

In order to enable the network capability of lighting apparatuses and other devices involved in an LMS, these are equipped with communication modules, for example for wireless and/or wired communication between the devices and, if necessary, with further active elements. For a functional LMS, components such as network-compatible sensors or protocol converters are required for communication using different network protocols.

The known lighting apparatuses are usually implemented on the basis of existing components, which can lead to cost-intensive homogeneous or uniform implementations, for example based on digital addressable lighting interface (DALI) components (DALI is a registered trademark of the DALI Alliance). Heterogeneous implementations are also known, in which, for example, DALI components, Zigbee components (Zigbee is a registered trademark of the Connectivity Standards Alliance), and/or Bluetooth components (Bluetooth is a registered trademark of the Bluetooth Special Interest Group) are used.

However, both uniform and mixed implementations often result in a high degree of redundancy in hardware components. This makes light management components, and thus also light management systems, complex and correspondingly expensive.

### SUMMARY

An object of the present disclosure is to find a way to simplify lighting management systems so that they can be provided at low cost.

To solve this object, a driver for a lighting device is provided according to a first aspect. The driver comprises a power section or power module for providing electrical power to at least one light source of the lighting apparatus, and a control unit for controlling the power section. The driver may also comprise peripheral electronics for supplying voltage to the power section and/or the control unit. In network-compatible drivers with a communication module, the voltage supply is usually already implemented.

The driver also comprises a communication module or network communication module for representing the lighting apparatus externally, in particular within an LMS. In particular, the communication module may be configured to establish a communication between the driver and other network devices of the LMS so that the lighting apparatus is represented within the LMS.

The communication module can in particular be configured to establish a communication with network devices of the LMS based on one or several wireless or wired communication protocols. Communication protocols such as Bluetooth, Zigbee, DALI, LoRa (registered trademark of Semtech Corporation), etc. can be used.

The driver also comprises an interface for connecting at least one peripheral device to the driver, wherein the control unit is configured to operate in a control mode or open control mode in which at least one peripheral device connected to the interface can be represented externally via the communication module of the driver, in particular within the LMS, in particular as an independent network participant.

The interface can be designed in particular for connecting one or several sensors, input devices and/or other peripheral devices and comprise one or several connectors, terminals and/or optocouplers.

The control unit may, for example, be configured as a microcontroller or comprise a microcontroller. In particular, the control unit may comprise a processor, a memory unit for storing data and machine-readable instructions for the processor, and an interface. The interface of the control unit can in particular be configured to establish a functional connection with the interface of the driver, with the communication module and with the power section of the driver. By writing different data and/or machine-readable instructions to the memory unit, the control unit can be configured differently as required, for example to execute certain control steps. In particular, the control unit can be configured by writing corresponding software to the memory unit and/or by firmware.

The control mode of the control unit, in which the at least one peripheral device can be represented externally via the communication module, is referred to below as “open control mode,” in contrast to a closed control mode, in which the at least one peripheral device is not represented externally via the communication module, see also below.

An open control mode refers in particular to a control mode of the control unit in which the communication module of the driver functions as the communication module of at least one peripheral device connected to the interface in order to represent this device in the LMS. This allows other participants in the LMS to perceive the at least one peripheral device as an independent network-compatible device. This means that, in principle, every function provided by the peripheral device can be made available to the entire LMS.

In the open control mode of the control unit, the communication module of the driver can thus serve as the communication module of the at least one peripheral device, so that even if it does not have its own communication module, it can act as an independent network device or endpoint within the LMS.

The network participants of an LMS can thus draw on shared resources, instead of independent active components such as Zigbee sensors or Zigbee drivers, their own controllers, antennas, or power supplies, thereby significantly reducing the redundancy of hardware components. By reducing the number of active components, lighting management systems can thus be implemented cost-effectively and sustainably.

In the case of a network-compatible sensor light, each network participant (light-emitting diode (LED) driver and sensor) usually has components that can also be shared. These include, for example, microcontrollers (MCUs), peripheral electronics, in particular filters and/or power supplies. Interface components such as communication modules, antennas, connectors, optocouplers, etc. can also be shared if necessary.

Furthermore, logic components, software and firmware, computing power and/or further resources can also be made available to the network devices for shared use.

In order to operate a sensor in a network, for example within an LMS, it may therefore be sufficient to give the control unit or microcontroller electrical or digital access to a sensor.

The control unit can be configured to control the communication module in open control mode in such a way that the communication module can represent both the lighting apparatus and the at least one peripheral device externally. The driver thus enables two or more endpoints, for example Zigbee endpoints, to be provided in a resource-efficient manner, in particular based on a single communication module. Since network-compatible lighting or luminaires generally require at least one driver or LED driver that can already provide all the necessary (system) components, the driver is particularly well suited for the proposed implementation.

The control unit can be configured in particular to control the communication module in the open control mode for essentially simultaneous and/or alternately repeating representation of the lighting apparatus and the at least one peripheral device. This ensures in particular that the lighting apparatus and the at least one peripheral device are essentially continuously available to the LMS as LMS endpoints.

The control unit can also be configured to operate in a closed control mode, in which no peripheral device connected to the interface is represented externally via the communication module. In the closed control mode, only the lighting apparatus is represented as an independent endpoint in the LMS. It is also conceivable that in the closed control mode, at least some of the functions provided by peripheral devices, for example sensor data provided by a sensor, are made available to the LMS. In contrast to open control mode, the at least one peripheral device is not represented externally as an independent network device or network endpoint with its own “network identity.”

In some embodiments, the control unit is configured to detect or query the current assignment or status of the interface and to execute the control at least in part based on the current assignment of the interface. For example, the control unit can detect whether a peripheral device of a certain type is connected to the interface and perform the control at least partially based on the type of the peripheral device. This allows a driver with plug-and-play functionality to be implemented so that the driver can automatically configure itself depending on the assignment of the interface.

The control unit can be configured to perform the control in a basic mode if the query reveals that the interface is not occupied. In the basic mode, the basic functions of the lighting apparatus can be provided, in particular without any functional extension by additional peripheral devices.

In some embodiments, the interface is configured to connect at least one sensor for providing sensor data and/or signals, wherein the control unit can be configured to control the communication module for transmitting the sensor data or signals to at least one further network device, in particular within an LMS. In particular, the control unit may be configured to make the sensor data received from the at least one sensor available to the entire LMS via the communication module.

In some embodiments, the interface comprises at least one information or data interface and/or at least one power interface for supplying power to the at least one peripheral device. It is also conceivable that the power interface and data interface coincide, in that an interface functions as both a data and power interface between a peripheral device and the driver. Thus, the peripheral electronics of the driver can also be used to supply power to at least one peripheral device connected to the interface. The control unit or microcontroller of the driver can be implemented in a scalable manner (e.g. oversized), so that there are practically no limits to the type of sensors/peripheral devices that can be connected. In particular, the interface can be used with different peripheral devices or sensors of different types, for example, radio frequency (RF), passive infrared (PIR), touch sensors, buttons, etc. A sensor designed as an active component can also operate without its own power supply, as the supply voltage is provided by the driver, in particular via the interface.

A fundamental idea behind the embodiments described here is, in particular, to utilize the active components present in a networkable lighting apparatus to expand or extend the functionality of light management systems. This is because the drivers or LED drivers of networkable lighting apparatuses, which are represented by the driver in a network, usually have all the resources required for networked sensor applications, with the exception of peripheral devices and sensors.

In order to utilize these resources available in the drivers for expanding LMS, it is proposed to provide an interface (e.g. connector, terminal or similar) for connecting at least one peripheral device or sensor and to configure the control unit for operation in a corresponding operating mode.

For example, the light or lighting apparatus itself and a sensor can be made available in an open control mode of the control unit as independent, self-sufficient components in an LMS. This operating mode of the lighting apparatus extended by the sensor can also be referred to as “autonomous operation” of the components.

If, for example, the control unit is operated in a closed control mode, the sensor connected to the driver can take over functions for controlling one or several lights on the basis of local logic. In this case, sensor functions or sensor data can be made available to other network devices or the LMS. This operating mode can also be referred to as “controller/peripheral mode” or “master/slave mode,” wherein the sensor is assigned a subordinate role in the network hierarchy, in particular without its own “network personality.”

According to a second aspect, a lighting apparatus is provided, wherein the lighting apparatus comprises at least one light source and a driver according to the first aspect for driving the at least one light source. The advantages, effects and further developments of the lighting apparatus result from the advantages, effects and further developments of the driver described above.

In particular, the lighting apparatus can be used in a variety of ways due to the different operating modes of the driver. For example, the lighting apparatus can be operated in a basic mode when the driver's interface is not occupied and the control unit is operated in basic mode. In the basic mode, the lighting apparatus can, for example, provide a basic functionality of a network-compatible lighting apparatus, wherein the lighting apparatus is represented in an LMS by the communication module of the driver.

If the driver interface is occupied by a peripheral device, the lighting apparatus can be operated as a lighting apparatus with extended functionality, for example as a sensor light. In the closed control mode of the control unit, the functionality of the connected peripheral device is essentially limited to the lighting apparatus itself. In the open control mode of the control unit, on the other hand, the peripheral device can essentially be made available to the entire LMS as an independent network-compatible device. In this way, the network devices, in particular network-compatible lighting apparatuses, can access shared resources. This simplifies the overall hardware of an LMS and reduces the redundancy of components, in particular active components.

According to a third aspect, a LMS is provided. The LMS comprises at least one lighting apparatus according to the second aspect, wherein the communication module of the driver is configured to represent the lighting apparatus within the LMS. Advantages and effects as well as further developments of the LMS result from the advantages and effects as well as further developments of the lighting apparatus described above. To avoid repetition, reference is therefore made to the previous description in this regard.

The invention will now be explained in more detail with reference to the accompanying figures. The same reference numbers are used in the figures for identical or similarly functioning parts.

### BRIEF DESCRIPTION OF THE DRAWINGS

FIG. 1 shows a schematic block diagram of a lighting apparatus with a driver according to one embodiment.

FIG. 2 shows an example of a peripheral device for connecting to the interface of the driver according to an embodiment.

FIG. 3 schematically illustrates a first operating mode of the driver according to an embodiment.

FIG. 4 schematically illustrates a second operating mode of the driver according to an embodiment.

FIG. 5 schematically illustrates a further operating mode of the driver according to an embodiment.

FIG. 6 schematically illustrates a further operating mode of the driver according to an embodiment.

### DETAILED DESCRIPTION

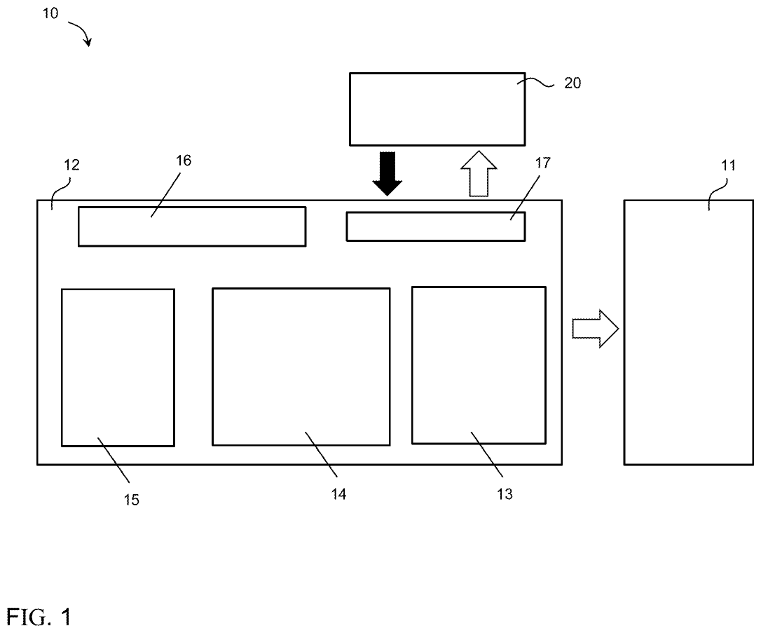

FIG. 1 shows a schematic block diagram of a lighting apparatus 10 with a driver 12 according to an embodiment. The lighting apparatus 10 according to the embodiment shown comprises a light source 11 and a driver 12 for driving the light source 11. The light source 11 may, in particular, comprise one or several LED light sources, and the driver 12 may be designed as an LED driver for driving the LED light sources.

The driver 12 comprises a power section 13 for supplying electrical power to the light source 11, a control unit 14 for controlling the power section 13, and peripheral electronics 15 for supplying voltage to the power section 13 and the control unit 14 of the driver 12. The transmission of electrical power from the power section 13 to the light source 11 is symbolized in FIG. 1 by a horizontal open arrow.

The driver 12 further comprises a communication module 16 or network communication module for representing the lighting apparatus 10 externally. In particular, the communication module 16 may be configured to establish communication between the driver 12 of the lighting apparatus 10 and other network devices (not shown) within an LMS. In the embodiment shown, the communication module 16 is configured as Zigbee communication module so that the lighting apparatus 10 can communicate with other network devices of the LMS based on the Zigbee protocol.

The driver 12 further comprises an interface 17 or a terminal, wherein the interface 17 is configured to connect external devices, in particular external peripheral devices, to the driver 12. For example, the interface 17 may be configured in the form of a plug connector.

FIG. 1 also schematically shows a peripheral device 20 connected to the interface 17. In the embodiment shown, the peripheral device 20 is designed as a sensor for providing sensor data.

The interface 17 comprises a data interface (not shown) for transmitting sensor data to the control unit 14 of the driver 12, symbolized by the vertical filled arrow.

The interface 17 also comprises a power interface (not shown) for transferring electrical power from the peripheral electronics 15 of the driver 12 to the peripheral device 20, symbolized by the vertical open arrow.

The control unit 14 comprises a processor, a memory unit for storing data and machine-readable instructions for the processor, and an interface, wherein the interface is designed to provide a functional connection between the control unit 14, the interface 17, the communication module 16, the peripheral electronics 15, and the power section 13. For simplicity, the processor, the memory unit, and the interface of the control unit 14 are not shown in FIG. 1.

The control unit 14 can be configured, in particular, by storing data and/or machine-readable instructions. In the embodiment shown, the control unit 14 is configured so that it can be operated in a basic mode, an open mode, and a closed mode.

In some embodiments, the control unit 14 is configured to query the current occupancy of the interface 17 and operate in the basic mode if the query reveals that the interface 17 is unoccupied or vacant. In the basic mode of the control unit 14, basic functions of the lighting apparatus 10 are provided. The basic functions may include, for example, controlling the light source 11 in such a way that stable operation of the lighting apparatus 10 is ensured. The basic function also may include receiving control commands via the communication module 16 and controlling the light source 11 of the lighting apparatus 10 in accordance with the received control commands.

If, when querying the assignment of the interface 17, it is determined that the interface 17 is assigned to one or several peripheral devices 20, various scenarios are conceivable. In particular, the occupancy of the interface 17 can have different effects depending on whether the control unit 14 is operated in an open or closed control mode.

If, for example, the control unit 14 is operated in an open control mode, the control unit 14 can, in particular in addition to its basic functions, ensure that the peripheral device 20, as an independent network device, has access to other network devices via the communication module 16. Thus, the communication module 16 of the driver 12 also can function as a communication module 16 of the peripheral device 20 for representing the peripheral device 20 within the LMS. In particular, the control unit 14 can be configured to control the communication module 16 in the open control mode in such a way that the lighting apparatus 10 or the light source 11 and the peripheral device 20 are represented externally essentially simultaneously and/or alternately. The lighting apparatus 10, thus, represents two essentially independent network points or end points—namely, the lighting apparatus 10 itself or light source 11 and the peripheral device 20—by a single communication module 16. Thus, the peripheral device 20 can be made available to the entire LMS or other network devices, thereby simplifying the overall structure of the LMS and reducing component redundancy.

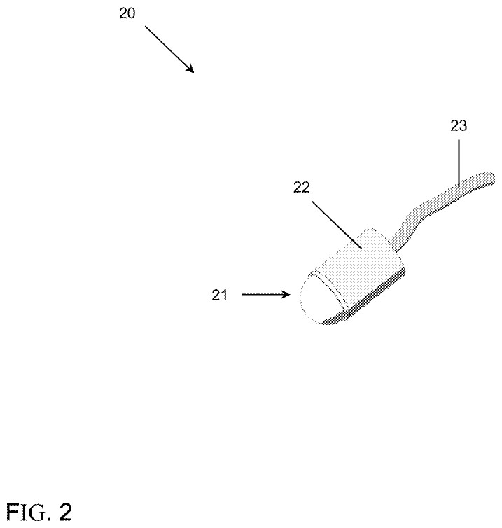

FIG. 2 shows an example of a peripheral device 20 for connection to the interface 17 of the driver 12 according to one embodiment. In the embodiment shown, the peripheral device 20 is a PIR motion sensor and comprises a sensor element 21 with a light-transmissive window or lens for detecting infrared light, a housing 22 for mounting the sensor, and electrical connection lines 23. The electrical connection can be configured, in particular, to be electrically connected to the interface 17 of the driver 12, if necessary by a plug.

As described in FIG. 1 above, the peripheral device 20 can access the hardware resources of the driver 12 in order to participate in an LMS as an independent network unit or network endpoint, which can significantly simplify it. Conventional sensors may have an integrated “overhead” of additional electronic components to ensure the network capability of the sensors. This also makes conventional sensors larger and more expensive.

FIG. 2 is intended, in particular, to illustrate that the driver 12 described here makes it possible to give relatively simple constructed peripheral devices their own network capability. In particular, a peripheral device 20 in a slimmed-down version or minimal design, in particular without its own communication module 16 and/or peripheral electronics 15, can act as a stand-alone network-capable device.

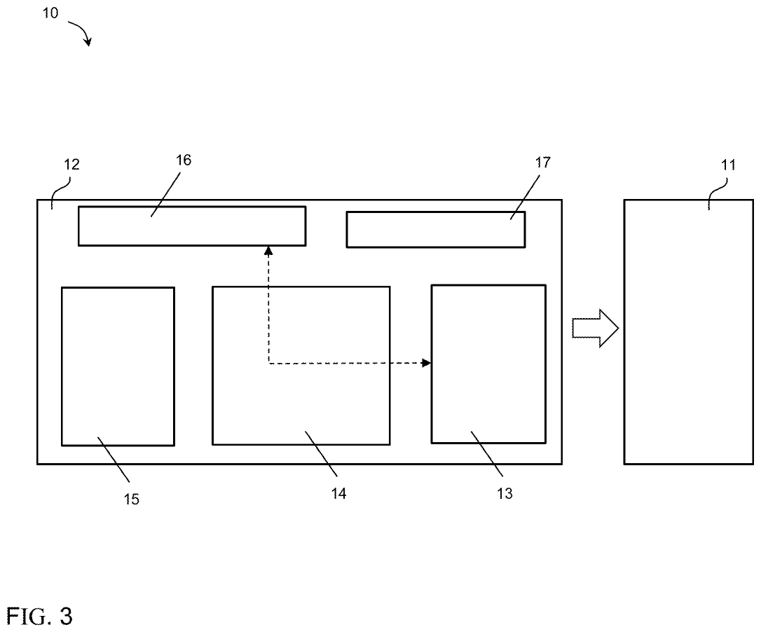

FIG. 3 schematically illustrates a first operating mode of the driver 12 according to an embodiment. In the case shown in FIG. 3, the interface 17 of the driver 12 is not occupied (i.e., the lighting apparatus 10 is not connected to any peripheral device 20 via the interface 17).

The control unit 14 can control the power section 13 of the driver 12, at least in part, based on the data and machine-readable instructions stored in the memory unit (not shown). Furthermore, the control unit 14 can exchange data and/or signals with other network participants of the LMS via the communication module 16. In particular, the control unit 14 can receive control commands via the communication module 16 and control the power section 13 of the lighting apparatus 10 at least in part based on the received control signals.

Connecting the lighting apparatus 10 to the LMS via the communication module 16 enables the lighting apparatus 10 to be represented as a network-compatible device or endpoint in the LMS. In particular, when operated without a connected sensor and/or other peripheral device 20, the driver 12 behaves like a simple Zigbee LED driver in accordance with its basic function. The representation of the lighting apparatus 10 in the LMS is symbolized in FIG. 3 by a dashed line running across the control unit 14 and connecting the communication module 16 to the power section 13.

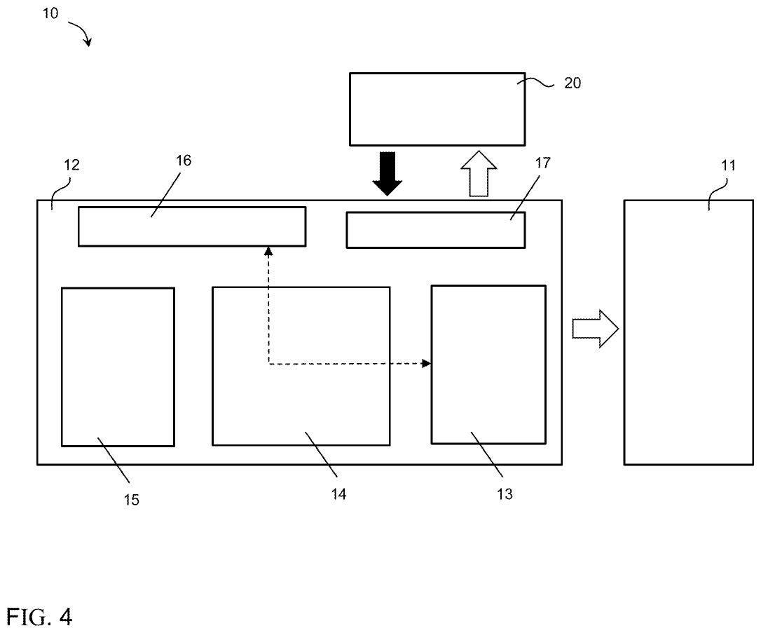

FIG. 4 schematically illustrates a second operating mode of the driver 12 according to an embodiment. In FIG. 4, the interface 17 is connected to a peripheral device 20, in particular a sensor. The operating mode of the driver 12 shown corresponds to a closed control mode of the control unit 14.

Without assigning the interface 17, the driver 12 behaves according to its basic function, as a, in particular, conventional Zigbee LED drivers (compare FIG. 3 above).

If, for example, a sensor is connected to the interface 17 during operation of the control unit 14 in closed control mode or “controller/peripheral mode,” the control unit 14 can recognize the sensor and receive sensor data supplied by the sensor via the interface 17, see the black vertical arrow. The sensor can be supplied with power by the peripheral electronics 15 of the driver 12 via the power interface (not shown), see open vertical arrow.

The control unit 14 can be configured to provide local functions of a sensor light based on the received sensor data. In particular, the control unit 14 can be configured to evaluate the sensor data and to control the power section 13 at least in part based on the sensor data.

Similar to the operating mode shown in FIG. 3, the lighting apparatus 10 can be represented in the LMS via the communication module 16, see dashed line in FIG. 4. Compared to the example in FIG. 3, the operation of the lighting apparatus 10 is thus supported by the sensor. It is therefore a networkable sensor-enabled lighting apparatus or sensor light. In particular, the sensor can control the light in which it is installed and make the control data available to further Zigbee lights so that they can then follow the sensor's control commands.

The control unit 14 also can be configured to forward the sensor data to other network devices within the LMS via the communication module 16. In this case, the control unit 14 is in what is known as closed operating mode, as the peripheral device 20 is not represented externally.

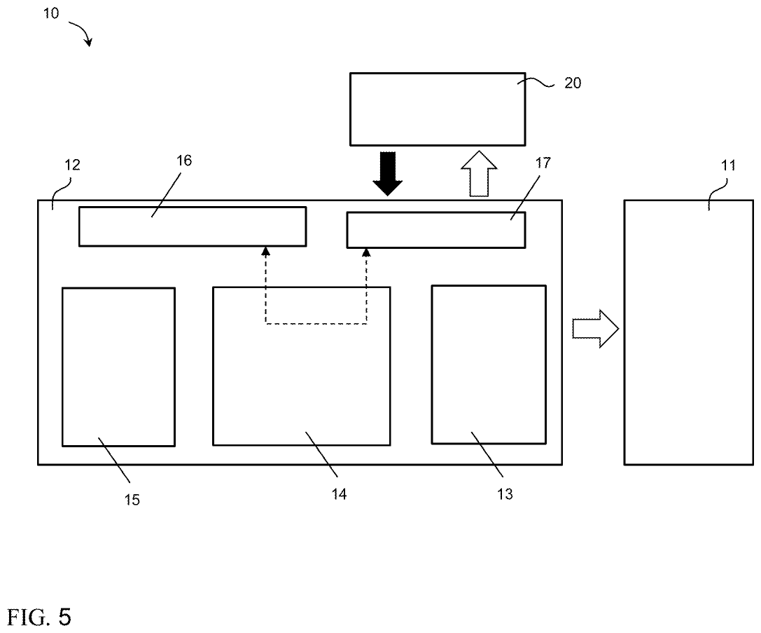

FIG. 5 schematically illustrates a further operating mode of the driver 12 according to an embodiment. The case shown in FIG. 5 essentially corresponds to the case shown in FIG. 4, with the difference that the control unit 14 is in a so-called open control mode. If, for example, a sensor is connected to the interface 17 during operation of the control unit 14 in open control mode, the control unit 14 can recognize the sensor and provide the network with a fully-fledged or autonomous Zigbee sensor endpoint. In particular, the control unit 14 can control the communication module 16 in such a way that the communication module 16 enables the peripheral device 20 to have independent access to the LMS. This is illustrated in FIG. 5 by a dashed line connecting the interface 17 and the communication module 16. Thus, the peripheral device 20 or the sensor can essentially act as an independent peripheral endpoint or sensor endpoint within the LMS. The control unit 14 thus functions as a kind of gateway that enables the peripheral device 20 to access the LMS.

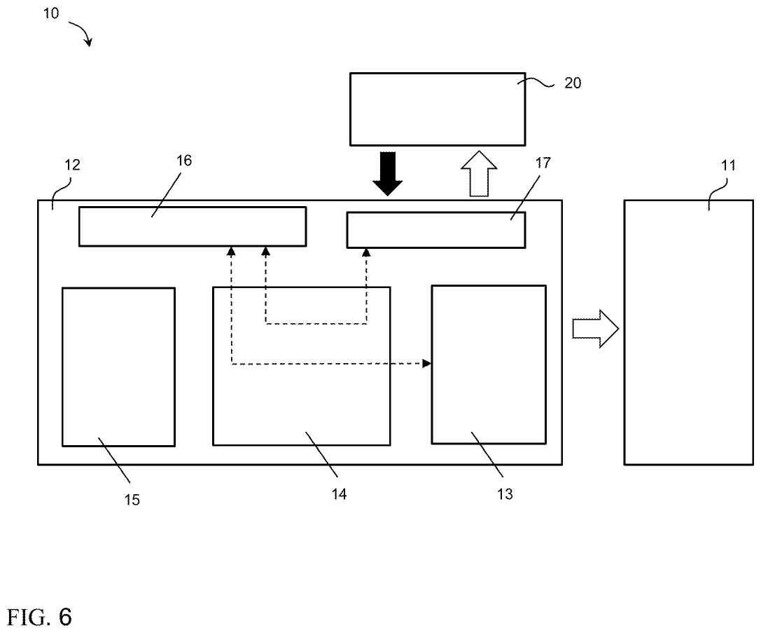

FIG. 6 schematically illustrates yet further operating mode of the driver 12 according to an embodiment. The operating mode shown in FIG. 6 essentially corresponds to the open operating mode shown in FIG. 5, in which the peripheral device 20 is represented externally by the communication module 16. In FIG. 6, however, both the peripheral device 20 and the lighting apparatus 10 itself are represented externally as network devices by the communication module 16 (compare both dashed lines in FIG. 6).

In particular, FIG. 6 is intended to illustrate that the peripheral device 20 or sensor and the lighting apparatus 10 can essentially be represented simultaneously as fully-fledged network devices in the LMS. It is also conceivable that the control unit 14 provides the communication module 16 with different, for example alternating, IDs for transmission to the LMS, so that from the perspective of the LMS, the peripheral device 20 and the lighting apparatus 10 are perceived as two or more different network devices. In this example, these are a lighting endpoint and a sensor endpoint, which can be used individually in an LMS.

FIGS. 3-6 illustrate the versatile applications of the proposed driver 12. The open control mode of the control unit 14 described here also makes it possible to expand the functionality of an LMS with few active components, such as communication and/or peripheral modules, in a simple and cost-effective manner. For example, the use of minimalist peripheral devices or sensors can enable the implementation of complex systems which can open up new, particularly data-based, business areas. The use of minimalist peripheral devices enables a simple and space-saving design of end products, in particular lighting apparatuses 10 or light sources 11. In addition, this allows the implementation of particularly user-friendly lighting apparatuses 10 or lighting systems, as the end user does not need to install any extra cables, for example for the power supply.

In some embodiments, the driver 12 comprises a control interface for receiving control commands and/or user inputs. For example, the driver 12 may have a near-field communication (NFC) interface for receiving user commands. The control interface can be used, in particular, to switch the control unit 14 to the modes described above as required.

The solution proposed here also allows for greater transparency at the information technology (IT) infrastructure level, in particular in larger projects. Because the devices are independent of each other despite sharing hardware resources, further services such as energy reporting and diagnostics can continue to be provided independently.

The driver 12 also offers a platform solution or a driver sensor platform for providing LMS with reduced complexity and fewer components or stock keeping units (SKUs).

A key feature of the solution proposed here is, in particular, the provision of two or more physical devices that can be used independently (or jointly) by sharing commonly required resources. This is achieved by relatively simple means, essentially at no extra cost, in particular by connecting an input of the control unit 14 or microcontroller, for example general purpose input/output (GPIO), externally or to the interface 17 and configuring the control unit 14 with appropriate software or firmware. In this way, for example, a sensor can share all the hardware resources of an LED driver, resulting in significant cost reductions at the luminaire and LMS level.

In addition to the significant cost savings for luminaires through the reduction of redundant hardware components, the driver 12 offers easy expandability of existing products, in particular luminaires and sensor luminaires, for small, medium and large or more complex applications.

The sensor and luminaire can be used in a network or LMS network as an endpoint (in closed control mode) or as independent LMS endpoints (in open control mode).

The resource sharing concept described above can reduce product costs to such an extent that the use of lighting products in the areas of data infrastructure, Internet of Things (IoT) or for new business models takes on particular significance. Existing luminaires or drivers, in particular standard drivers, can be easily expanded or upgraded so that even more complex products can be realized with a relatively short time to market (T2M).

Although at least one exemplary embodiment has been shown in the foregoing description, various changes and modifications may be made. The embodiments mentioned are merely examples and are not intended to limit the scope, applicability or configuration of the present disclosure in any way. Rather, the preceding description provides the skilled person with a plan for implementing at least one exemplary embodiment, whereby numerous changes can be made in the function and arrangement of elements described in an exemplary embodiment without departing from the scope of protection of the appended claims and their legal equivalents. In addition, according to the principles described herein, several modules or several products can also be connected to each other in order to obtain further functions.

### REFERENCE SIGNS AND NUMERALS

10. Lighting apparatus
11. Light source
12. Driver
13. Power Supply
14. Control Unit
15. Peripheral Electronics
16. Communication Module
17. Interface
20. Peripheral Device
21. Sensor Element
22. Housing
23. Electrical Connection Lines

What is claimed is:

1. A driver configured to drive a lighting apparatus, the driver comprising:
a power section configured for providing electrical power to at least one light source of the lighting apparatus;
a control unit configured for controlling the power section;
a communication module configured for representing the lighting apparatus externally; and
an interface configured for connecting at least one peripheral device to the driver;
wherein the control unit is further configured to be operated in an open control mode in which the at least one peripheral device is represented externally as an independent network device via the communication module of the driver.

2. The driver according to claim 1, wherein the control unit is configured to control the communication module in the open control mode such that the communication module represents both the lighting apparatus and the at least one peripheral device externally.

3. The driver according to claim 2, wherein the control unit is configured to control the communication module in the open control mode to represent the lighting apparatus and the at least one peripheral device substantially simultaneously and/or alternately.

4. The driver according to claim 1, wherein the control unit is configured to be operated in a closed control mode in which no peripheral device connected to the interface is represented externally via the communication module.

5. The driver according to claim 1, wherein the control unit is configured to query a current assignment of the interface and to execute the control of the power section at least partially based on the current assignment of the interface.

6. The driver according to claim 5, wherein the control unit is further configured to execute the control of the power section in a basic mode when the querying of the interface reveals that the interface is not occupied.

7. The driver according to claim 1, wherein:
the interface is configured for connecting at least one sensor configured for providing sensor data; and
the control unit is configured to control the communication module in transmitting the sensor data to at least one further network device.

8. The driver according to claim 1, wherein the interface comprises at least one information interface and/or at least one power interface configured for supplying voltage to the at least one peripheral device.

9. A lighting apparatus comprising:
the driver according to claim 1; and
the at least one light source;
wherein the communication module is configured to represent the lighting apparatus within a light management system.

10. A light management system comprising the lighting apparatus according to claim 9 wherein the communication module of the driver is configured to represent the lighting apparatus within the light management system.
